(19) United States
(12) Patent Application Publication
(10) Pub. No.: US 2018/0009032 A1
(43) Pub. Date: Jan. 11, 2018

(54) METAL OBJECTS AND METHODS FOR MAKING METAL OBJECTS USING DISPOSABLE MOLDS

(71) Applicant: GENERAL ELECTRIC COMPANY, Schenectady, NY (US)

(72) Inventors: Rajendra Madhukar KELKAR, Cincinnati, OH (US); Pong Kwok CHAN, Niskayuna, NY (US); Singh PRABHJOT, Guilderland, NY (US); Michael John MCCARREN, Alpha, OH (US); Arunkumar NATARAJAN, Niskayuna, NY (US); John T. LEMAN, Niskayuna, NY (US)

(21) Appl. No.: 15/205,661

(22) Filed: Jul. 8, 2016

(51) Int. Cl. B22F 3/10; B22F 1/00; B22F 3/15; B22F 5/10; B22C 9/24; B29L 31/00

(52) U.S. Cl. CPC B22F 3/1017; B22F 5/10; B33Y 80/00; B22C 9/24; B22F 1/0062; B22F 3/15; B22F 2005/103; B33Y 10/00; B33Y 50/02; B22F 2201/02; B22F 2301/15; B22F 2302/45; B22F 2998/10; B29L 2031/757; B22F 2001/0066

(57) ABSTRACT

Methods of making metal objects are provided. These methods generally involve adding a metal powder slurry into a sacrificial mold, such as a mold made by three dimensional printing, and heating the slurry/mold mixture. The heating steps may include curing the slurry to make a green part inside the mold, debinding to burn off the mold and binder to make a brown part, sintering, and hot isostatic pressing. Metal products, such as aircraft engine parts, are also provided.

### FIELD OF THE INVENTION

Methods of making metal objects using a sacrificial mold are provided. These methods generally involve adding a metal powder slurry into a sacrificial mold, such as a mold made by three dimensional printing, and applying one or more heating steps to produce a solid metallic object. Products used in and made by these methods are also provided.

### BACKGROUND

Many systems, such as next generation turbine engines, require components and parts having intricate and complex geometries and/or bulk parts. Conventional techniques for manufacturing engine parts and components involve laborious processes, such as investment or lost-wax casting. This process generally requires creating a wax pattern around a ceramic core, coating the wax pattern with a ceramic slurry to form a ceramic shell mold, melting the wax, heating the ceramic, pouring molten metal into the ceramic mold (i.e., to fill the void left by the wax), solidifying the molten metal, and removing ceramic core and shell from the solidified metal. The final product may then undergo additional post-casting modifications, such as drilling. Therefore, while investment casting is capable of manufacturing various metal parts, this process is time-consuming and expensive.

Metal injection molding (MIM) is another known method of making metal parts. This method involves injecting a viscous mixture of metal powder and a binder (collectively, known as “feedstock”), under high pressure, into a metallic mold assembly to create a “green” body or part. The green body or part is treated (e.g., with heat, solvent, or a catalytic method) to remove the binder (“debinding”), resulting in a “brown” body or part. The “brown” body or part is heated at high temperatures in a process known as “sintering,” which removes any remaining binder and gives the part its final shape.

MIM parts tend to have a weight range within 0.1 to 250 grams, wall thicknesses not more than 12.7 mm (0.5 in.), and a distance from gate to the farthest point on the part should be around four inches. MIM is incapable of directly making metal parts having complex, 3-D geometries in a one piece for topological reasons due to the need for mold pull planes and separability (e.g., the mold must be physically separated from the green body). To the extent MIM can be used to make certain complex structures, it may require multi-piece deconvolution of the geometry, multi-piece molding, and additional assembly and joining steps. MIM also requires the use of complex, expensive metallic molds that sometimes take months to fabricate and thus are impractical for prototypes, development parts, and small production runs. Furthermore, the viscosity of known MIM slurries limits their use to metal molds capable of withstanding significant forces (e.g., 5000-8000 psi) needed to inject those slurries into the mold.

Direct Metal Laser Melting (DMLM), Direct Metal Laser Sintering (DMLS), and Selective Laser Sintering (SLS) are other methods of making metal parts. These methods generally use a focused laser to fuse, layer-by-layer, a three dimensional object from a bed of powdered material. These methods are capable of manufacturing metal parts, but may result in products having cracks, a rough surface finish that requires post-production machining, and non-equiaxed microstructures.

### SUMMARY OF VARIOUS EMBODIMENTS OF THE INVENTION

Methods for preparing metal objects and metal products made by such methods are provided. In one aspect, a metal powder slurry is introduced into a sacrificial mold, and one or more heating steps are applied to produce a solid metallic body and remove the sacrificial mold. In another aspect, the sacrificial mold is prepared using a three dimensional (3-D) printing process. In a particular aspect, the method involves (a) creating a 3-D numerical model of a hollow component having an external wall; (b) creating a synthetic model of said component from said numerical model having a corresponding synthetic external wall; (c) introducing a metal powder slurry into the synthetic model; and (d) applying one or more heating steps to produce a solid metallic body. In another particular aspect, the sacrificial mold is removed either during or after applying the one or more heating steps.

In another aspect, the sacrificial mold has an internal opening or void, which defines a particular three dimensional internal cavity or body. In another aspect, the mold has an internal opening defining a three dimensional body in addition to having an external geometry. In another aspect, processes of manufacturing metal materials, components, or structures having particular internal or external geometries or features are provided. These processes involve creating a mold through the three dimensional printing process and incorporating or injecting one or more metal powder slurries into the mold.

In any of the aspects described herein, the metal powder slurry comprises a metal powder and a binder. In a particular aspect, the metal alloy powder is a superalloy powder, such as a nickel-chromium superalloy. In other aspects, the binder comprises a polymer or wax/polymer binder. In other aspects, more than 50% of the total volume of the slurry is metal powder. In yet other aspects, the slurry has a viscosity of 10-100 Pascal seconds (Pa-s) at room temperature.

In any of the aspects described herein, the one or more heating steps may comprise curing, debinding, and sintering. In a particular aspect, the methods involve preparing a green body after introducing the metal powder slurry into a mold, curing the green body, debinding the cured green body to produce a brown body, and sintering the brown body to prepare a metal object. In some aspects, the curing comprises heating at a temperature between 50-70° C. for 6-24 hours under nitrogen. In other aspects, the debinding involves heating at a temperature of 300-600° C. In yet other aspects, the sintering step is performed at a temperature in the range of 1000-1600° C. In any of the aspects described herein, at least one step of hot isostatic pressing may be applied after the one or more heating steps.

The methods described herein may provide numerous advantages over known methods of making metal products. For example, the methods can produce true 3-D geometries in a single piece article without resorting to multi-piece deconvolution of the geometry, multi-piece molding and the additional assembly and joining steps. The methods can make complex shapes without hard tooling, provide the ability to rapidly adjust tooling design, and can be used for rapid prototyping. These methods are more convenient, efficient, and cost-effective than conventional methods, such as investment and/or lost-wax casting.

The methods differ from MIM technology. For example, the methods have the ability to make more defined and/or more complex objects (e.g., objects having internal 3-D geometries, curved geometries) compared to MIM. As discussed above, the methods described herein can make complex, 3-D geometries in a single piece that cannot be made using conventional mold tooling. Moreover, MIM requires that any internal features be oriented (e.g., perpendicular to the pull plane) to facilitate removal from a mold. Also, unlike MIM, the methods do not require a high pressure system to prepare a green part. For example, the pressure levels used in MIM (e.g., 5000-8000 psi) would not be suitable for injecting a metal slurry into the disposable mold (e.g., plastic, disposable mold) described herein. The methods described herein, unlike MIM, do not require expensive metal molds, and thus provide a cost-effective, efficient and practical platform for making prototypes, developmental parts, and small production number runs.

The methods also provide an alternative to direct, 3-D printing processes for making metal parts. For example, metal parts made by the methods described herein do not tend to crack (e.g., during fabrication due to rapid thermal transients) and may have a better surface finish that products made by additive processes, such as SLS using metallic powder, DMLS, or DMLM. The metal products described herein can have equiaxed microstructures.

Additional features and advantages of the methods and products described herein will be seen and understood from the following detailed description.

### BRIEF DESCRIPTION OF THE DRAWINGS

FIG. 1 shows an overview of an exemplary method for creating a 3-D model of a part (first panel), a printed sacrificial mold (second panel), casting a metal slurry (third panel), a cured green part (fourth panel), a debinded part (fifth panel), and a sintered part (sixth panel).

FIG. 2 shows exemplary bulk parts after curing (second and fourth part), and after debinding and sintering (first and third parts).

FIG. 3 shows enlarged images showing the grain structure of an exemplary metal object after sintering.

FIG. 4 shows an exemplary object made, and the level of detail obtained, using an exemplary metal powder slurry described herein.

### DETAILED DESCRIPTION OF VARIOUS EMBODIMENTS OF THE INVENTION

Methods for preparing metal objects and metal objects made by such methods are provided. These methods involve introducing a metal powder slurry into a sacrificial mold, and performing one or more heating steps to produce a sold metal object, such as a bulk metal part, and to remove the sacrificial mold.

Methods of producing metal objects using disposable (or sacrificial) molds are provided. The molds are made of materials that can be removed by thermal and/or mechanical methods. In particular aspects, the sacrificial mold is removed by heat.

The disposable mold is generally manufactured from a casting composition that comprises an organic polymer. The organic polymer can be selected from a wide variety of thermoplastic polymers, thermosetting polymers, blends of thermoplastic polymers, or blends of thermoplastic polymers with thermosetting polymers. The organic polymer can comprise a homopolymer, a copolymer such as a star block copolymer, a graft copolymer, an alternating block copolymer or a random copolymer, ionomer, dendrimer, or a combination comprising at least one of the foregoing types of organic polymers. The organic polymer may also be a blend of polymers, copolymers, terpolymers, or the like, or a combination comprising at least one of the foregoing types of organic polymers. The disposable mold is generally manufactured in a rapid prototyping process, such as a 3-D printing process.

Examples of suitable organic polymers are natural and synthetic waxes and fatty esters, polyacetals, polyolefins, polyesters, polyaramides, polyarylates, polyethersulfones, polyphenylene sulfides, polyetherimides, polytetrafluoroethylenes, polyetherketones, polyether etherketones, polyether ketone ketones, polybenzoxazoles, polyacrylics, polycarbonates, polystyrenes, polyamides, polyamideimides, polyarylates, polyurethanes, polyarylsulfones, polyethersulfones, polyarylene sulfides, polyvinyl chlorides, polysulfones, polyetherimides, or the like, or a combinations comprising at least one of the foregoing polymeric resins.

Blends of organic polymers can be used as well. Examples of suitable blends of organic polymers include acrylonitrile-butadiene styrene, acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations comprising at least one of the foregoing blends of organic polymers.

Exemplary organic polymers are acrylonitrile-butadiene styrene (ABS), natural and synthetic waxes and fatty esters, and ultraviolet (UV) cured acrylates. Examples of suitable synthetic waxes are n-alkanes, ketones, secondary alcohols, beta-diketones, monoesters, primary alcohols, aldehydes, alkanoic acids, dicarboxylic acids, omega-hydroxy acids having about 10 to about 38 carbon atoms. Examples of suitable natural waxes are animal waxes, vegetal waxes, and mineral waxes, or the like, or a combination comprising at least one of the foregoing waxes. Examples of animal waxes are beeswax, Chinese wax (insect wax), Shellac wax, whale spermaceti, lanolin, or the like, or a combination comprising at least one of the foregoing animal waxes. Examples of vegetal waxes are carnauba wax, ouricouri wax, jojoba wax, candelilla wax, Japan wax, rice bran oil, or the like, or a combination comprising at least one of the foregoing waxes. Examples of mineral waxes are ozocerite, Montan wax, or the like, or a combination comprising at least one of the foregoing waxes.

As noted above, the disposable mold can be manufactured from thermosetting or crosslinked polymers such as, for example, UV cured acrylates. Examples of crosslinked polymers include radiation curable or photocurable polymers. Radiation curable compositions comprise a radiation curable material comprising a radiation curable functional group, for example an ethylenically unsaturated group, an epoxide, and the like. Suitable ethylenically unsaturated groups include acrylate, methacrylate, vinyl, allyl, or other ethylenically unsaturated functional groups. As used herein, “(meth)acrylate” is inclusive of both acrylate and methacrylate functional groups. The materials can be in the form of monomers, oligomers, and/or polymers, or mixtures thereof. The materials can also be monofunctional or polyfunctional, for example di-, tri-, tetra-, and higher functional materials. As used herein, mono-, di-, tri-, and tetrafunctional materials refers to compounds having one, two, three, and four radiation curable functional groups, respectively.

Exemplary (meth)acrylates include methyl acrylate, tert-butyl acrylate, neopentyl acrylate, lauryl acrylate, cetyl acrylate, cyclohexyl acrylate, isobornyl acrylate, phenyl acrylate, benzyl acrylate, o-toluyl acrylate, m-toluyl acrylate, p-toluyl acrylate, 2-naphthyl acrylate, 4-butoxycarbonylphenyl acrylate, 2-methoxycarbonylphenyl acrylate, 2-acryloyloxyethyl-2-hydroxypropyl phthalate, 2-hydroxy-3-phenoxy-propyl acrylate, ethyl methacrylate, n-butyl methacrylate, sec-butyl methacrylate, isobutyl methacrylate, propyl methacrylate, isopropyl methacrylate, n-stearyl methacrylate, cyclohexyl methacrylate, 4-tert-butylcyclohexyl methacrylate, tetrahydrofurfuryl methacrylate, benzyl methacrylate, phenethyl methacrylate, 2-hydroxyethyl methacrylate, 2-hydroxypropyl methacrylate, glycidyl methacrylate, and the like, or a combination comprising at least one of the foregoing (meth)acrylates.

The organic polymer may also comprise an acrylate monomer copolymerized with another monomer that has an unsaturated bond copolymerizable with the acrylate monomer. Suitable examples of copolymerizable monomers include styrene derivatives, vinyl ester derivatives, N-vinyl derivatives, (meth)acrylate derivatives, (meth)acrylonitrile derivatives, (meth)acrylic acid, maleic anhydride, maleimide derivatives, and the like, or a combination comprising at least one of the foregoing monomers.

In a particular aspect, the disposable mold is made using a 3-D printing process to form a variety of geometrical shapes and/or molds for the fabrication of metal objects and products.

3-D printing technology is a manufacturing process where a structure is built layer-by-layer with the assistance of computer programs, such as a Computer Aided Design (CAD) program. The CAD software, for example, helps in fabricating each planar layer by depositing a building material in certain X, Y, and Z coordinates until a final three dimensional structure is complete. With 3-D printing, there is no need to develop or manufacture patterns or tools (i.e., casts or molds) to fabricate parts, thereby significantly decreasing the build times. Those of skill in the art will appreciate that a variety of computer software programs may be used, so long as it is capable of programming specific coordinates in the fabrication of the disposable mold during the build process. In several aspects, a method of using a 3-D printing process that moves and fabricates in three dimensions (e.g., in the X, Y, and Z directions) is provided. In other aspects, a fabrication process that moves in two dimensions where the manufacturing process produces the product in strips, one layer at a time is also provided. In other aspects, emerging technologies using a two dimensional array of mirrors to form an entire part layer at once, requiring movement in only one direction, the Z direction, is also encompassed herein.

There are various types of 3-D printing technologies available to those of skill in the art and the particular type selected for the fabrication of the disposable mold will depend on the material used in its production. One type of 3-D printing may include liquid-based methods, which apply photocurable polymer resins to form each part layer. These might include stereolithography (SLA), jetted photopolymer, or ink jet printing. For example, SLA printing is a well-known technique that can be described as a process that utilizes a liquid plastic resin that is selectively cured with ultraviolet light in thin cross sections. The thin cross sections are formed layer-by-layer.

Another type of printing includes powder based printing process, such as selective laser sintering (SLS) using non-metallic powders and three dimensional printing (3DP). In each of these powder based fabrication methods, powdered material is melted or sintered to form each part layer. For example, in one aspect, the SLS process utilizes powdered plastic materials selectively sintered by a laser layer-by-layer. Another form of printing includes a solid-based process, which use non-powdered materials that are layered one on top of another and subsequently converted to the desired shape. This method includes laminated object manufacturing (LOM), or fused deposition modeling (FDM).

In general, the 3-D printing methods described herein are capable of preparing a negative of the real (or authentic) object to be fabricated. The outer surface is offset by adding a wall to allow for functioning as a mold. There is empty space in the synthetic mold, where solid material (e.g., metal powder slurry) can be introduced. In one aspect, the negative is directly printed using a FDM or SLA machine.

The 3-D printing processes described herein can fabricate molds out of virtually any type of material generally known and used in the 3-D printing process, such as the polymers discussed above. For example, the manufacturing process can be made from a polymeric material, such as ultraviolet curable thermosets (e.g., epoxy, resin, urethane, cyanoacrylate, photopolymers, etc.) and powdered materials (e.g., nylon, glass filled nylon, polycarbonate, wax, metal, and sand bonded with heat cured resin). Other materials which would be readily apparent to those in the field may also be used in the process.

Representative materials used in the 3-D printing process can include any of the polymers discussed above, such as thermoset and thermoplastic polymers. Representative thermoset polymers may include, for example, polymers belonging to the class of polyester, polyurethane, vulcanized rubber, a phenol-formaldehyde resin, duroplast, urea formaldehydes, melamine resin, diallyl-phthalate (DAP), epoxy resin, polyimides, or cyanate esters or polycyanurates or combinations thereof.

Representative thermoplastic polymers may include, for example, polymers belonging to the class acrylic, acrylonitrile butadiene styrene, nylon, polylactic acid, polybenzimidazole, polycarbonate, polyether sulfone, polyetherether ketone, polyetherimide, polyethylene, polyphenylene oxide, polyphenylene sulfide, polypropylene, polystyrene, polyvinyl chloride, Teflon, or combinations thereof.

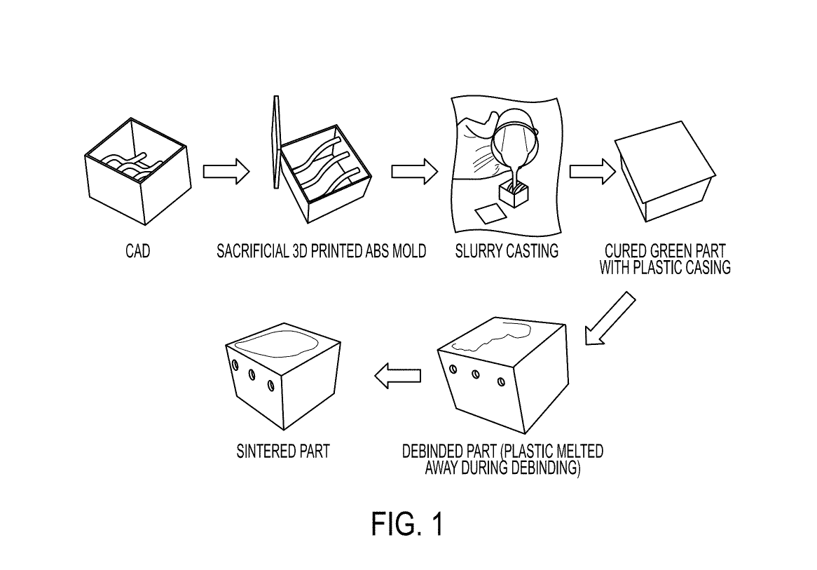

In another aspect, metal objects, parts or structures, such as airplane engine parts, are created that have intricate or complex internal and external geometries. In conventional investment casting techniques, introduction of materials into a casting mold results in the production of structures, components, or parts have specific external geometries. However, should a specific internal geometry be required, a positive object is used to make a corresponding negative feature of that same size and shape in the cast article. These specific geometries are dictated by the external mold or internal core in which they are introduced. In several aspects, the fabrication of a disposable mold used in the casting process results in a product having specific internal and external geometries without the need to separately produce an internal mold and/or core. An exemplary method of making a metal object having internal geometries, and the metal object made, is shown in FIG. 1.

The term “internal geometry” is generally understood to mean any cavity, hollow, or opening having a complex or simple shape or geometry enclosed within an external geometry. A representative example, of an internal geometry may be found in FIG. 1, second panel (inside the printed mold).

The term “external geometry” is generally understood to mean an outer shape or configuration of a body or three dimensional body. A representative example of an external geometry may be found in FIG. 1, second panel (outside of the printed mold).

Disposable molds and methods for making such molds that can be used herein are described in U.S. Pat. Nos. 7,413,001 and 8,413,709, which are hereby incorporated by reference in their entireties.

As discussed herein, a metal powder slurry is introduced into a disposable (sacrificial) mold. The metal powder slurry has a low viscosity and is introduced into the disposable mold under low pressure such that the mold is not deformed or distorted. The metal powder slurry is also introduced at a temperature lower than 50° C., such as room temperature. These conditions, e.g., low viscosity slurry, low pressure and temperature introduction (or injection), differ from known methods of making metal products, such as MIM, that use metal molds. For example, the pressure used in a MIM process (e.g., 5000-8000 psi) would result in deformation or distortion of the plastic molds described herein. Also, in MIM, the slurry is injected at high temperatures (e.g., 100-300° C.), which would substantially weaken, distort, or decompose the candidate plastic material employed as a disposable mold.

The metal powder slurry comprises metal powder and a binder. The metal powder may be any metal or metal alloy, such as a metal or metal alloy having a density of 23 g/cm³ to 2 g/cm³, including, but not limited to, as copper, nickel, copper nickel, cobalt, brass, bronze, cadmium, nickel chromium cobalt, nickel chromium, copper zinc, iron nickel, iron, aluminum, titanium, iron-based alloys, nickel-based alloys, cobalt-based, or aluminum-based alloys. The metal alloy powder may be a metal superalloy powder, such as a nickel-chromium superalloy (e.g., Inconel alloy powder, such as Inconel 625 or Inconel 718). The metal powder may be more than 50%, 60%, 65%, 70%, 75%, or 80% of the total volume of the metal powder slurry.

The slurry includes a binder material, such as monomers and/or oligomers that provide a low viscosity system. For example, the slurry may comprise acrylic based monomers (e.g., 1,6-hexanediol diacrylate), trimethylolpropane triacrylate (TMPTA), diethylene glycol diacrylate, isobornyl acrylate (IBOA), triethylene glycol dimethacrylate (TEGDM), trimethylolpropane propoxylate triacrylate (TMPPTA), diurethane dimethacrylate (DUDMA), acryloyl morpholine (ACMO), ethoxylated (3) trimethylolpropane triacrylate (Sartomer SR454).

As discussed herein, after the metal powder slurry is introduced into the disposable mold, liquid monomers and/or oligomers can be made to polymerize and/or crosslink to form a firm, strong gel matrix or “green body”. The gel matrix immobilizes the metal powder into the desired shape of the mold in which the slurry mixture is gelled. The resultant “green” product exhibits sufficient strength and toughness (i.e., is not brittle, resists tearing, cracking, etc.) for handling.

The viscosity of the curable slurry can vary from 10-100 Pascal-seconds (Pa-s), 30-80 Pa-s, or 50-65 Pa-s at room temperature.

An initiator can be added to the slurry in order to activate polymerization of any monomers present. The initiator may be a free-radical initiator. Examples of suitable free-radical initiators include ammonium persulfate, ammonium persulfate and tetramethylethylenediamine mixtures, sodium persulfate, sodium persulfate and tetramethylethylenediamine mixtures, potassium persulfate, potassium persulfate and tetramethylethylenediamine mixtures, azobis[2-(2-imidazolin-2-yl) propane] HCl (AZIP), and azobis(2-amidinopropane) HCl (AZAP), 4,4′-azo-bis-4-cyanopentanoic acid, azobisisobutyramide, azobisisobutyronitrile (abbreviated AIBN), azobisisobutyramidine hydrochloride, 2-2′-azo-bis-2-(methylcarboxy) propane, 2-hydroxy-1-[4-(hydroxyethoxy)phenyl]-2-methyl-1-propanone, 2-hydroxy-2-methyl-1-phenyl-1-propanone, or the like, or a combination comprising at least one of the aforementioned free-radical initiators. Some additives or co-monomers can also initiate polymerization, in which case a separate initiator may not be desired. The initiator can control the reaction in addition to initiating it. The initiator is used in amounts of about 0.005 wt % and about 0.5 wt %, based on the weight of the casting composition.

Other initiator systems, in addition to free-radical initiator systems, can also be used in the casting composition. These include ultraviolet (UV), x-ray, gamma-ray, electron beam, or other forms of radiation, which could serve as suitable polymerization initiators. The initiators may be added to the casting composition either during the manufacture of the casting composition or just prior to casting.

Dispersants/surfactants, flocculants, and suspending agents can also be optionally added to the casting composition to control the flow behavior of the composition. Dispersants/surfactants make the composition flow more readily, flocculants make the composition flow less readily, and suspending agents prevent particles from settling out of composition.

In some embodiments, the metal power slurry is prepared as follows. A metal powder, binder, and surfactant are mixed. ⅛ inch spherical grinding media balls are added as a mixing aid. The mixture is mixed using, for example, a planetary centrifugal mixer until a homogenous slurry is obtained. The slurry is then cooled to room temperature. A thermal initiator is added and the contents are mixed (e.g., using planetary centrifugal mixer) until the thermal initiator is homogenously dispersed. The balls are removed, and the resulting slurry is directly poured into the molds. If needed, a vacuum can be applied during the mixing process inside the mixer to remove air, which could facilitate thermal curing step of the green part.

In a particular embodiment, IN625 nickel alloy (e.g., 70-74% by volume) is mixed with a 1,6 hexanediol diacrylate and a surfactant (Evonik Variquat CC-42NS). 6-12 Y-stabilized zirconia (YSZ), ⅛ inch spherical balls are added and the mixture is mixed in a dual asymmetric centrifugal mixer at 2000 rpm for 2 minutes. The mixing can be repeated one or two more times until a homogenous slurry is obtained. The slurry is cooled for 10-15 mins. AIBN is added and the contents are mixed in a rotary mixer at 450 rpm for 3 minutes. The initiator mixing process can be repeated one more time, while degassing the mixture. The YSZ balls are removed, and the resulting slurry is directly poured into the molds.

After the metal powder slurry is introduced into the disposable mold (e.g., made by 3D printing), one or more heating steps, such as curing, debinding, and sintering are performed. In one aspect, the slurry is cured using temperatures less than 100° C. under nitrogen, such as at 50°−70° C. for 4-24 or 4-18 hours under nitrogen, or 55° C. for 6-18 hours under nitrogen. In a particular embodiment, molds are cured in an oven maintained at 45-60° C. under positive flow of nitrogen for 4-8 hours to make the green part.

In another aspect, the product is debinded and sintered, e.g., following curing. These processes result in removal or elimination of the mold and binder. A person of skill in the art will appreciate that the debinding and sintering temperatures depend on the materials (e.g., metal, binder) used. In one aspect, the debinding step is performed at a temperature range of 100-600° C., 300-600° C., or 400-500° C. In another aspect, the sintering step is performed at a temperature of 1000-1300° C. Additionally, debinding may be done in different atmospheres, such as hydrogen, argon, and/or vacuum depending on metal and binder used. In other aspects, the conditions used in the Examples may be used.

After the one or more heating steps, the resulting product may undergo post-processing steps to minimize internal defects, such as porosity and voids. Post-processing may be conducted using a suitable technique, such as, for example, extrusion, hot isostatic processing (HIP), heat treatment, and the like.

Metal products, such as metal products made using the processes described herein, are also provided. In one aspect, a disposable mold comprising a metal powder slurry is provided. The disposable mold and metal powder slurry may comprise any of the materials discussed above. In another aspect, a metal object or part, such as an airplane engine part, made by the methods described herein is provided. In another aspect, the metal object or part has one or more internal geometries not visible from an external line of sight. For example, the internal geometry can be a curved structure or structure oriented not perpendicular to the pull plane to facilitate removal from the mold. In other aspects, the metal object has 3-D geometries produced in a single piece article without, for example, requiring multi-piece deconvolution of the geometry, multi-piece molding and/or additional assembly and joining steps.

In some embodiments, metal objects comprising non-linear, internal cavities and that have isotropic and/or equiaxed microstructures are provided. These metal objects may also have a roughness average (Rₐ) of less than 100, less than 80, or less than 65 micro-inches. In other aspects, the metal objects have a Rₐ of 60-400 micro-inches, 60-300 micro-inches, 60-200 micro-inches, 60-100 micro-inches, or 100-200 micro-inches. The roughness of the metal objects is significantly lower than, for example, metal objects made using DMLM, which tends to have an Rₐ of 400 to 1000 micro-inches. The metal objects can be made using the methods described herein, and may result in metal objects having densities greater than 99%.

Those of skill in the art will recognize that other embodiments may be utilized, which include changes that do not alter or depart from the scope of the invention. These and other embodiments will become more apparent during the description of a specific example.

### EXAMPLES

### Example 1

Plastic molds for an aircraft engine part were prepared using a 3-D printing technique, such as Fused Deposition Modeling (FDM). A metal powder slurry formulation (Table 1) was introduced into the molds.

TABLE 1
Inconel 625 Acrylic Slurry Formulation

| | Mass | Density | Volume | | |
|---|---|---|---|---|---|
| Component | (g) | (g/ml) | (cm³) | Mass % | Vol % |
| Inconel 625 (16 μm) | 100.30 | 8.44 | 11.88 | 95.09 | 69.88 |
| 1,6 hexanediol | 4.83 | 1.01 | 4.78 | 4.58 | 28.12 |
| diacrylate (HDDA) | | | | | |
| Variquat CC-42NS | 0.25 | 1.04 | 0.24 | 0.24 | 1.41 |
| (Dispersant/Surfactant) | | | | | |
| AIBN | 0.10 | 1.00 | 0.10 | 0.09 | 0.59 |
| (Free radical initiator) | | | | | |
| Total | 105.48 | | 17.00 | 100.00 | 100.00 |

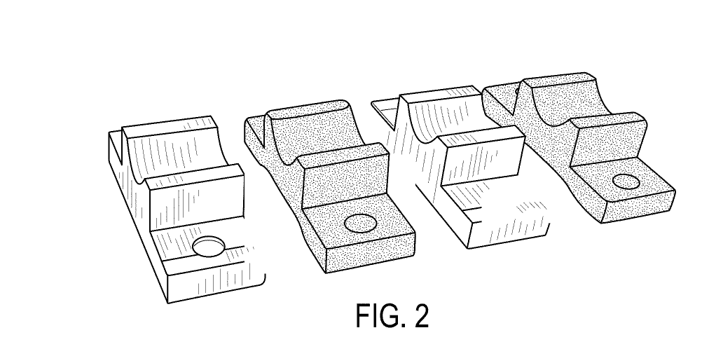

The calculated density of the uncured slurry is 6.205 g/cm³. The slurry was cured at 55° C. for 12 hours under nitrogen. The cured pieces are shown in FIG. 2 (the second and fourth parts).

The cured parts were debinded using the temperature profile and atmospheric conditions shown in Tables 2 and 3.

TABLE 2
Debinding Profile - Temperature

| Initial Temp | Set Temp | Ramp Rate | Soak Time |
|---|---|---|---|
| (° C.) | (° C.) | (° C./min) | (h) |
| 25 | 200 | 3 | 0.5 |
| 200 | 350 | 1 | 3 |
| 350 | 500 | 1 | 3 |
| 500 | 25 | 8 | 1 |

TABLE 3
Debinding Atmospheric Conditions

| | Flow rate |
|---|---|
| Gas | (Standard cubic feet per hour) |
| Nitrogen | 25 |
| Oxygen | 2 |

Total carbon and oxygen content was determined with Leco CS844 (C) and ONH836 (0) induction furnace/inert gas fusion instruments, employing infrared absorption and gas chromatographic detectors. Table 4 shows the results of the elemental analysis; values tabulated are the average of 3 measurements, with the uncertainty expressed as ±1 standard deviation of the mean.

TABLE 4
Elemental Analysis using LECO Instrument

| Sample # | Sample Description | C (wt %) | O (wt. %) |
|---|---|---|---|
| 1 | IN625 powder | 0.0307 ± 0.0012 | 0.120 ± 0.001 |
| 2 | Molded Part | 0.0276 ± 0.001 | 0.476 ± 0.018 |
| | (Debinded/Sintered) | | |
| 3 | Molded Part | 0.0274 ± 0.001 | 0.453 ± 0.014 |
| | (Debinded/Sintered) | | |

The debinded parts were sintered using the profile shown in Table 5. Sample 1 in Table 4 is the raw material 1N625 powder (no binder) used in the study. Sample 2 is a debinded/sintered IN625 part made in a 3-D plastic mold and using the formulation described in Table 1. Sample 3 is a replicate debinded/sintered IN625 part subjected to same conditions as Sample 2.

The results show no carbon pickup and thus the binder used in the metal powder slurry was burned off. The oxygen content is higher than the original powder indicating some oxidation of IN625 during the debinding and sintering conditions used in this example.

TABLE 5
Vacuum Sintering Profile

| | Heating Rate | Set Point | Soak Time | Cooling Rate |
|---|---|---|---|---|
| Steps | (° C./min) | (° C.) | (h) | (° C./min) |
| 1 | 10 | 1150 | 2 | NA |
| 2 | 10 | 1250 | 6 | NA |
| 3 | NA | 20 | N/A | 10 |

The sintered pieces are shown in FIG. 2 (the first and third parts).

The roughness of the parts was determined and is shown in Table 6.

TABLE 6
Surface Roughness Measurements of
Metal Object Made with Plastic Mold

| Location | Roughness (micro-inches) |
|---|---|
| 1 | 129.01 |
| 2 | 146.68 |
| 3 | 129.25 |
| 4 | 138.85 |
| Average | 135.95 |

This example demonstrates that the processes described herein are capable of making metal objects using a disposable mold.

### Example 2

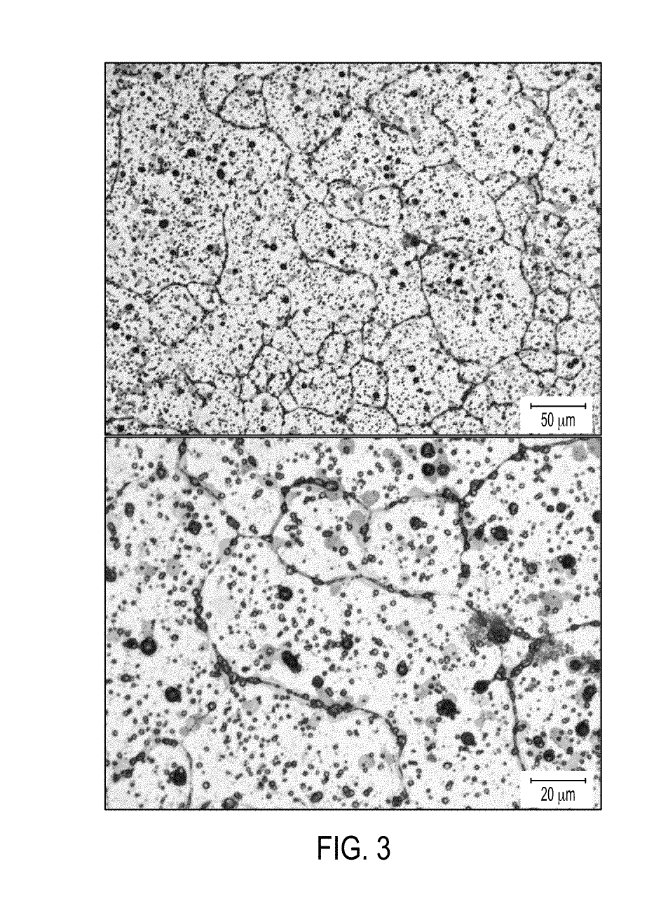

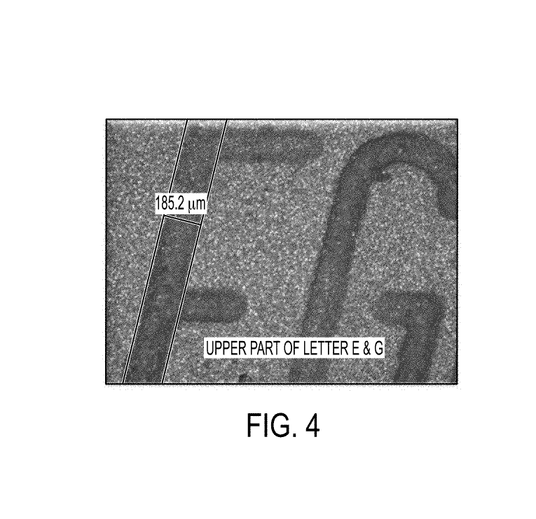

A silicone mold was made using a LEGO® piece as a pattern. A metal powder slurry (Table 1) was introduced into the mold to produce a green body. The green body was cured, debinded, and sintered using the conditions described in Example 1. A micrograph showing the grain structure of the metal piece is shown in FIG. 3, and a picture of the final product is shown in FIG. 4. In particular, it can be seen that the process was able to reproduce very fine details of the molded piece (a feature 185.2 μm wide).

The roughness of the parts was determined and is shown in Table 7.

TABLE 7
Surface Roughness Measurements of Metal
Object Made with Silicone Mold

| Location | Roughness (micro-inches) |
|---|---|
| 1 | 62.02 |
| 2 | 55.83 |
| 3 | 79.38 |
| 4 | 56.46 |
| Average | 63.42 |

This example confirms that the processes described herein are capable of making fine and equiaxed grain sizes for small, complex geometries.

1. A method for making a metal object comprising:
(a) introducing a metal powder slurry into a sacrificial mold; and
(b) applying one or more heating steps to produce a solid metallic body and eliminate the sacrificial mold.

2. The method of claim 1, wherein the sacrificial mold is removed by heating in the range of 100-600° C.

3. The method of claim 1, wherein said metal powder slurry comprises a binder and a metal powder.

4. The method of claim 3, wherein the metal powder is a metal alloy powder.

5. The method of claim 1, wherein more than 50% of the total volume of the slurry is metal powder.

6. The method of claim 1, wherein more than 65% of the total volume of the slurry is metal powder.

7. The method of claim 1, wherein the sacrificial mold is removed by heating in a carbon-free atmosphere comprising nitrogen and oxygen.

8. The method of claim 1, further comprising (i) producing a green body and curing said green body; (ii) debinding the cured green body to produce a brown body; and (iii) sintering the brown body to prepare a metal object.

9. The method of claim 8, wherein said curing comprises heating to a temperature between 50-70° C. for 6-24 hours under nitrogen.

10. The method of claim 9, wherein said curing comprises heating to a temperature of 55° C. for 18 hours under nitrogen.

11. The method of claim 10, wherein the brown body is sintered at a temperature in the range of 1000-1600° C.

12. The method of claim 1, further comprising at least one step of hot isostatic pressing after said applying one or more heating steps.

13. A method for making a metal object comprising:
(a) creating a 3-D numerical model of a hollow component having an external wall;
(b) creating a synthetic model of said component from said numerical model having a corresponding synthetic external wall;
(c) introducing a metal powder slurry into the synthetic model; and
(d) applying one or more heating steps to produce a solid metallic body; and
(e) during or after step (d) removing the synthetic model.

14. The method of claim 13, wherein the mold is removed by heating in the range of 300-600° C.

15. The method of claim 13, wherein said metal powder slurry comprises a binder and a metal powder.

16. The method of claim 15, wherein the metal powder is metal alloy powder.

17. The method of claim 13, wherein more than 50% of the total volume of the slurry is metal powder.

18. The method of claim 13, wherein more than 65% of the total volume of the slurry is metal powder.

19. The method of claim 13, wherein the mold is removed by heating in a carbon-free atmosphere comprising nitrogen and oxygen.

20. The method of claim 13, further comprising (i) producing a green body and curing said green body; (ii) debinding the cured green body to produce a brown body; and (iii) sintering the brown body to prepare a metal object.

21. The method of claim 20, wherein said curing comprises heating to a temperature between 50-70° C. for 6-24 hours under nitrogen.

22. The method of claim 21, wherein said curing comprises heating to a temperature of 55° C. for 18 hours under nitrogen.

23. The method of claim 13, wherein the brown body is sintered at a temperature in the range of 1000-1600° C.

24. The method of claim 13, further comprising at least one step of hot isostatic pressing after said applying one or more heating steps.

25. A metal object comprising a non-linear, internal cavity and isotropic and/or equiaxed microstructures.
